(19) United States
(12) Patent Application Publication
(10) Pub. No.: US 2015/0369300 A1
(43) Pub. Date: Dec. 24, 2015

(54) CLUTCH DISC, CLUTCH ASSEMBLY AND TORQUE TRANSFER DEVICE

(71) Applicant: Schaeffler Technologies AG & Co. KG, Herzogenaurach (DE)

(72) Inventors: Thorsten Biermann, Wachenroth (DE); Andreas Zeug, Schneittach (DE)

(21) Appl. No.: 14/720,087

(22) Filed: May 22, 2015

(30) Foreign Application Priority Data
Jun. 23, 2014 (DE) 102014211995.2

(51) Int. Cl. F16D 13/64; F16D 13/52; F16D 13/68

(52) U.S. Cl. CPC F16D 13/64; F16D 13/68; F16D 13/52; F16D 2300/12

(57) ABSTRACT

A clutch disc for a bracket of a clutch assembly, a clutch, a transmission or a differential of a drive train of a vehicle, with at least two sections, whereby the at least two sections of the clutch disc are arranged in the clutch disc in a radial direction of the clutch disc and are movable relative to one another. A clutch assembly for a clutch, a transmission or a differential of a drive train of a vehicle, with a clutch disc to transmit a torque resulting from an axial force, whereby the clutch disc is configured to be inherently movable in a radial direction of the clutch assembly in such a way, that a radial force can be established in the clutch assembly via the clutch disc, through which the torque is further transmissible.

### CROSS-REFERENCE TO RELATED APPLICATIONS

The present application claims priority under 35 U.S.C. §119 to German Patent Application No. DE 10 2014 211 995.2, filed on Jun. 23, 2014, which application is incorporated herein by reference in its entirety.

### TECHNICAL FIELD

The present invention concerns a clutch disc for a bracket of a clutch assembly, a clutch, a transmission or a differential of a drive train of a vehicle. The invention further concerns a clutch assembly for a clutch, a transmission or a differential of a drive train of a vehicle. In addition, the present invention concerns a clutch or a torque transfer system, in particular a dual clutch, an automatic transmission or a differential, for a drive train of a vehicle.

### BACKGROUND

An internal combustion engine of an automobile or a commercial vehicle provides the driver with a usable output only within a specific rotational-speed range. In order to be able to utilize this rotational-speed range for the vehicle's various driving conditions, it needs an automatic or a manual transmission or clutch transmission. Such a transmission or clutch transmission can be mechanically coupled to the internal combustion engine via a clutch. Due to various, as well as increased, demands on actuating forces, performance and engine torques of the clutch or the clutch transmission to be transmitted, a variety of clutches or clutch transmissions are used in the drive trains of vehicles. Used are, for example, wet-running multiple disc clutches, that are configured as individual, dual or multiple-plate clutches. In addition, wet-running multiple disc clutches are used in the automatic transmissions of utility vehicles, such as construction vehicles and special vehicles.

Besides the primary function of connecting and separating a crankshaft of the internal combustion engine and/or an output shaft of an electromotor with or from a gearbox input shaft of the vehicle, the clutch has a number of other important functions. It should allow a soft and smooth start of the vehicle, ensure quick shifting of the transmission, keep torsional vibrations of the internal combustion engine away from the transmission, thus reducing rattling noises and wear, serve as overload protection for the drive train, e.g., in the event of incorrect shifting, as well as be wear-resistant and as easy as possible to replace. In doing so, with a small space requirement in the drive train, the clutch should be as cost-efficient as possible in its assembly and operation. In a limited slip differential, a clutch has the function of a friction clutch and in utility vehicles a clutch also functions as a service or a parking brake (spring-loaded brake).

Due to cost pressure and demanded increased performance with ever smaller spaces in the drive trains of vehicles, issues that have to date caused only minor or simple to correct problems are increasingly coming into focus for developers. One such problem area exists in most dual clutches or automatic transmissions, e.g., with the comparatively small available spaces there. There is also a problem area for clutch transmissions for utility vehicles with an axially available space with a simultaneously efficient power transmission. To do this, quick automated shifting between a number of gears, e.g., is to be ensured, whereby a clutch assembly of the clutch transmission is to be configured compactly and the torques to be shifted are to be transmitted securely with low wear on a sustained basis.

One task of the invention is to provide both an improved clutch disc for a bracket of a clutch assembly, a clutch, a transmission or a differential of a drive train of a vehicle, as well as a corresponding clutch assembly. Another task of the invention is to define an improved clutch or an improved torque transfer system, in particular an improved dual clutch, an improved automatic transmission or an improved differential for a drive train of a vehicle. With the improved clutch disc or the improved clutch assembly, e.g., with unchanged external dimensions of a clutch assembly or a clutch, it should be possible to transmit an increased, in particular a comparatively significantly increased, torque.

In addition, according to the invention it should be possible to replace a clutch assembly or a clutch with a specific transmissible torque with a structurally smaller clutch assembly or clutch, without having to accept a loss of performance. Furthermore, the safely operable clutch assembly should have a small axial and/or radial space requirement, e.g., in the torque transfer system, with efficient power transmission. It should also have a structure that is constructively simple and compact, as well as easy to assemble, and it should be cost-effective in its manufacturing, assembly, operation and/or service as well.

### SUMMARY

According to aspects illustrated herein, there is provided a clutch disc for a first bracket of a clutch assembly, a clutch, a transmission or a differential of the drive train of a vehicle including at least two sections. The at least two sections of the clutch disc are arranged in the clutch disc in a radial direction of the clutch disc and are movable relative to one another.

According to aspects illustrated herein, there is provided a clutch assembly for a clutch, a transmission or a differential of a drive train of a vehicle including a clutch disc to transmit a first torque resulting from an axial force. The clutch disc is configured to be inherently movable in a radial direction of the clutch assembly in such a way, that a radial force can be established in the clutch assembly via the clutch disc, through which the torque is further transmissible.

The task of the invention is solved with a clutch disc for a bracket of a clutch assembly, a clutch, a transmission or a differential of a drive train of a vehicle with a clutch assembly for a clutch, a transmission or a differential of a drive train of a vehicle and with a clutch or a torque transfer system, in particular a dual clutch, an automatic transmission or a differential, for a drive train of a vehicle. Advantageous further developments, additional characteristics and/or advantages of the invention result from the following description.

In the following, the terms clutch assembly or clutch are generally to be understood to be a machine element that serves a mechanically separable connection of two preferred coaxial shafts, in particular an output shaft and a drive shaft of a vehicle, or two preferred coaxial machine elements. The clutch assembly according to the invention for a clutch or a clutch transmission can be used on all drive trains of vehicles, e.g., of automobiles or utility vehicles, and accordingly on all torque transfer systems. The preferred clutch assembly according to the invention is configured as a wet-running (multiple) clutch assembly, in particular a wet-running dual clutch system, for an automatic transmission.

The clutch disc according to the invention comprises two sections that are arranged in the clutch disc in radial direction of the clutch disc and/or in circumferential direction of the clutch disc, to be partially movable relative to one another. The entire clutch disc can primarily consist of sections that are partially movable relative to one another, whereby the sections are configured to be movable relative to one another in such a way that a preferred outer peripheral edge of the clutch disc can be fitted on a preferred inner peripheral edge of a second bracket and held by adhesive friction. In other words, the clutch disc possesses a certain inherent deformability, which in one condition, particularly in an engaged condition of a clutch assembly into which it is assembled, allows it to be fitted on the second bracket and held by adhesive friction, while in a second condition, in particular in a disengaged condition of the clutch assembly, it can essentially return to its previous shape. This form is preferentially also one form of the clutch disc when it is load-free and at rest.

For the design examples explained in the descriptions of the figures and the above preferred design example, the clutch disc is configured in such a way that its outer diameter, which is fitted inside on the peripheral edge of the second bracket and held by adhesive friction, can be enlarged in sections if necessary. In doing so, the clutch disc can be configured in such a way that its inside diameter can be reduced if necessary. This is preferentially due to the fact that, for the deformation of the clutch disc, preferably one or more of the peripheral sections of the clutch disc rotate, with regard to their respective centers, by a certain angle about an axial direction of the clutch assembly. It is of course possible to reverse this kinematically, whereby an inner peripheral edge of the clutch disc to an outer peripheral edge of the second bracket.

According to the invention the clutch disc can be configured on its preferred inner peripheral edge in such a way that, with it, it can be mounted onto the bracket in an essentially form-fitted and primarily non-rotatable manner, i.e. a certain amount of rotatability is intentionally given. The clutch disc can be configured in such a way that, through a preferred outer peripheral edge of the bracket complementary to the edge of the clutch disc, the sections of the clutch disc are movable relative to one another in radial direction and/or in peripheral direction. In other words, the relevant peripheral edges of the clutch disc and the bracket are configured to be complementary, e.g., via corresponding linear or corresponding curved ramps, in such a way that, for a relative rotation between the clutch disc and the bracket, the deformation of the clutch disc adjusts in such a way that the other peripheral edge of the clutch disc can be held on the peripheral edge of the second bracket.

In this way, it is possible, e.g., to give the peripheral edge of the clutch disc the form of a regular star or polygon with in particular rounded corners. On its corresponding peripheral edge, the bracket is then configured in a complementary way. The clutch disc can be configured as a spring washer, whereby at least two sections of the clutch disc are spring-mounted to one another with a spring element, primarily elastic in peripheral direction. In addition, the clutch disc can be configured as a wedge plate, whereby one section or one segment of the section is configured to approximate a wedge, which can be clamped between the bracket and the second bracket, i.e., the clutch disc can also be configured as a wedge spring washer.

In design examples of the invention, one segment or the clutch disc can exhibit an engaging section for a cam, a cog or a ramp of the bracket, through which the segment or the clutch disc is radially displaceable. Furthermore, a segment or the clutch disc can exhibit an engaging section for the peripheral edge of the second bracket, through which the segment or the clutch disc can be pressed to the second bracket. The cam, the cog or the ramp, in sections if necessary, can have a straight or a curved form. In particular the ramp, or a ramp of a cam or a cog, has a boundary in the form of an arc. According to the invention, the clutch disc can be held together in one piece, in one piece in terms of material or adhesively, and can be configured to be simple or integrated.

In embodiments of the invention, one section of the clutch disc can primarily be configured as a peripheral section of the clutch disc that extends primarily in radial and peripheral direction. In a first approximation, the clutch disc has the form of a circular ring with a comparatively small axial dimension. The clutch disc can, e.g., exhibit three, four, five, six, seven or eight sections. One individual section is preferentially configured primarily as a circular ring section, whereby a circular ring section preferably comprises two, three or four segments. The clutch disc can be configured as an inner clutch disc or an inner disc. In addition, the clutch disc is configured as a rotation component or a clutch rotating component.

The clutch assembly according to the invention exhibits a clutch disc to transmit a torque resulting from an axial force or an actuating force, whereby the clutch disc is configured to be inherently movable in a radial direction of the clutch assembly and/or in a peripheral direction of the clutch assembly in such a way that, by means of the clutch disc, a radial force can be established in the clutch assembly, through which the torque is further transmissible. The clutch disc is configured to be deformable in such a way that only in the engaged condition of the clutch assembly can a torque be transmitted via the radial force between the clutch disc and the clutch assembly.

In other words, to engage the clutch assembly, the clutch assembly is configured in such a way that the clutch disc is inherently movable or is moved in radial direction, so that a frictional contact between the clutch disc and the clutch assembly is established. That is, the clutch disc changes its form to such an extent that the frictional contact is established. When the clutch assembly disengages, the clutch disc moves back into its original form. The clutch assembly can exhibit two clutch rotating components and for each clutch rotating component at least one clutch disc, whereby the respective clutch rotating component is movably mounted in axial direction (Ax) with the relevant clutch disc and is held in an essentially form-fitted manner in a peripheral direction (Um) of the clutch assembly.

According to the invention, a first torque is transferable via an axially established force-fit between the clutch discs, and a second torque is transmissible via a radially established force-fit between the clutch discs and the second clutch rotating component. In other words, with the two clutch discs, due to the axial force, and with the clutch disc and the second clutch rotating component, due to the radial force resulting from the axial force and the geometry of the clutch disc, the entire torque is transmissible through the clutch assembly or via the clutch. In the process, the axial force essentially corresponds to an actuating force on the clutch assembly or the clutch.

In embodiments of the invention, the clutch disc comprises areas, that are arranged to be movable relative to one another in the clutch disc, whereby preferentially two directly adjacent areas with a spring element and/or with an essentially fixed connection to one another are provided, and a radial movability of two relevant areas of the clutch disc is realized via a spring element. For an engaged condition of the clutch assembly, the clutch rotating component fits at least one area of the clutch disc, at least in sections, on the second clutch rotating component by adhesive friction. This means that, for the engaged condition of the clutch assembly, the relevant area of the clutch disc moves radially outward and/or the inside in such a way that one edge of this area is positioned on the clutch rotating component. As a result a torque can be transmitted between the clutch disc and the clutch rotating component.

For a disengaged condition of the clutch assembly, because of the spring elements in the clutch disc, the relevant area of the clutch disc moves radially back again. It is preferred that this movement is an inherent rotating motion of the respective area—a rotational movement of the clutch assembly is disregarded here—about a defined, relatively small angle. The clutch rotating component can have at least one ramp or one depression, and one area of the clutch disc can have a complementary or corresponding engaging section, whereby with a relative rotation between the clutch rotating component and the clutch disc, the engaging section of the area of the clutch disc is radially (Ra) displaceable via the ramp or the depression. In doing so, an engaging section of the area of the clutch disc, preferably primarily opposite to the engaging section, can be fitted radially (Ra) on the clutch rotating component.

In embodiments of the invention, a gearing is configured between the clutch rotating component and the clutch disc, whereby, with a relative rotation of the clutch rotating component relative to the clutch disc, the gearing radially displaces the areas of the clutch disc. In doing so, a contour of the clutch disc, in particular a radius of the engaging section, can be aligned to a contour of the clutch rotating component, in particular a radius of the peripheral edge, at least there where the contour of the clutch disc can be fitted to the contour of the clutch rotating component, whereby in particular the relevant radii of the engaging section and the peripheral edge are essentially identical. That is, in sections, the clutch disc can exhibit larger radii on an outer edge than the radius of this (then unround) outer edge itself. This can be applied to the inner edge in an analogous manner.

The clutch rotating component is inserted in the clutch disc, whereby the gearing can be configured, e.g., as a slip gearing, such as a circular-arc gearing or an elliptical gearing, or as a slip-free gearing, such as an involute gearing etc. To do this, the clutch rotating component engages the clutch disc over preferably essentially, or primarily, an entire periphery. This can, of course, also be carried over to the second clutch rotating component and the second clutch disc. The clutch rotating component can also exhibit a cross section in the shape of a polygon or a regular star with in particular rounded corners. In addition, the clutch rotating component can exhibit a number of cams and/or cogs, that run preferably regularly in peripheral direction.

According to the invention, the clutch rotating component can be configured as a bracket, in particular an inner ring, and the clutch disc can be configured as an inner disc. Furthermore, the second clutch rotating component can be configured as a second bracket, in particular an outer ring, and the second clutch disc can be configured as an outer disc. In particular, the clutch disc of the clutch assembly according to the invention is configured as a clutch disc according to the invention. The clutch according to the invention, or the torque transfer system according to the invention, exhibits a clutch disc according to the invention and/or a clutch assembly according to the invention.

The invention is explained further in the following with reference to the attached detailed drawing. Elements or components that have an identical, univocal or analogous design and/or function have the same reference sign in the description and the list of reference signs, and/or are identified with the same reference sign in the figures of the drawing. Potential alternatives, not addressed in the description, not depicted in the drawing and/or not final, static and/or kinematic reversals, combinations etc. to the depicted and/or explained embodiments of the invention, or individual assemblies, parts or sections thereof, can be taken from the list of reference signs.

All the properties discussed, including those of the list of reference signs, can be used not only in the stated combination or the stated combinations, but also in one other combination or other combinations or on their own, without leaving the scope of the invention. Using the reference signs and their associated properties in the list of reference signs, it is in particular possible to substitute one property, or a number of properties, in the description of the invention and/or the descriptions of the figures. Furthermore, as a result, one property or a number of properties, can be laid out in more detail.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a three-dimensional exploded view onto a simple embodiment of a clutch assembly according to the invention with an embodiment of an inner clutch disc according to the invention;

FIG. 2 is a perspective view, partially open in radial and axial direction, of a second embodiment of the clutch assembly in assembled condition;

FIG. 3 is a perspective view, open from all sides, a detail of the clutch assembly according to the invention between the inner clutch disc and an outer bracket;

FIG. 4 is a two-dimensional front view of the clutch assembly from FIG. 2, shown cut in the area of one of its inner clutch discs;

FIG. 5 is a mechanical analogous model for a freed segment of the inner clutch disc to study a self-locking effect of the segment between the outer bracket and an inner clutch disc; and,

FIG. 6 is a line chart illustrating the required axial actuating force of a clutch assembly from the state of the art comparable to the clutch assembly according to the invention, with reference to a torque capacity.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

In the following, the clarification of the invention refers to axial direction Ax, rotational axis Ax, radial direction Ra and peripheral direction Um of a torque transfer system according to the invention 0 with clutch 1 according to the invention or clutch assembly 2 according to the invention of a drive train of a vehicle, such as, e.g., an passenger car, a passenger van, a motor cycle, a utility vehicle, a (heaviest) goods vehicle, a construction vehicle, a construction machine, a special vehicle etc., with a gasoline or a diesel engine. This information of positions also refers, e.g., to a crankshaft of the vehicle, the drive train, transmission 0, converter 0, differential 0, clutch 1 according to the invention, damper 1, clutch assembly 2 according to the invention and clutch disc 12 according to the invention. Clutch 1, or clutch assembly 2, is configured as multiple disc clutch 1 or multiple disc clutch assembly 2.

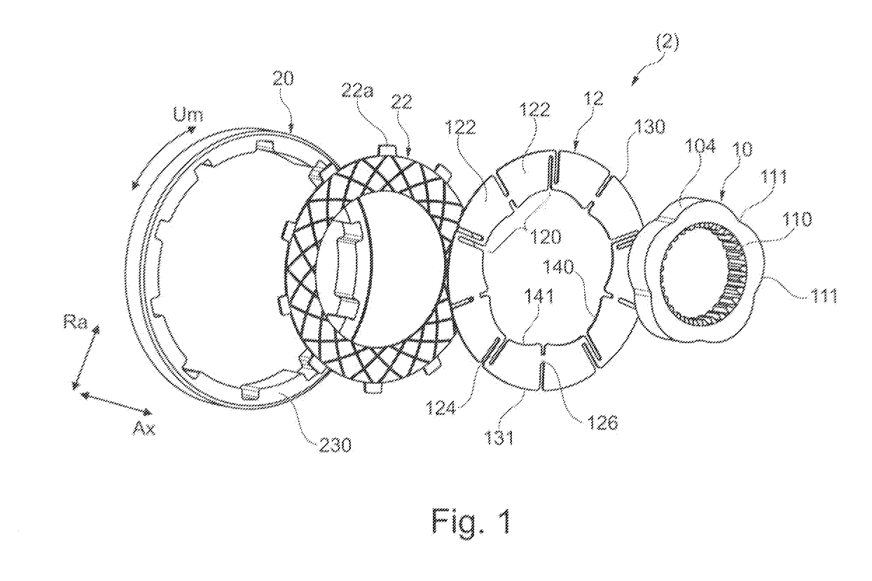

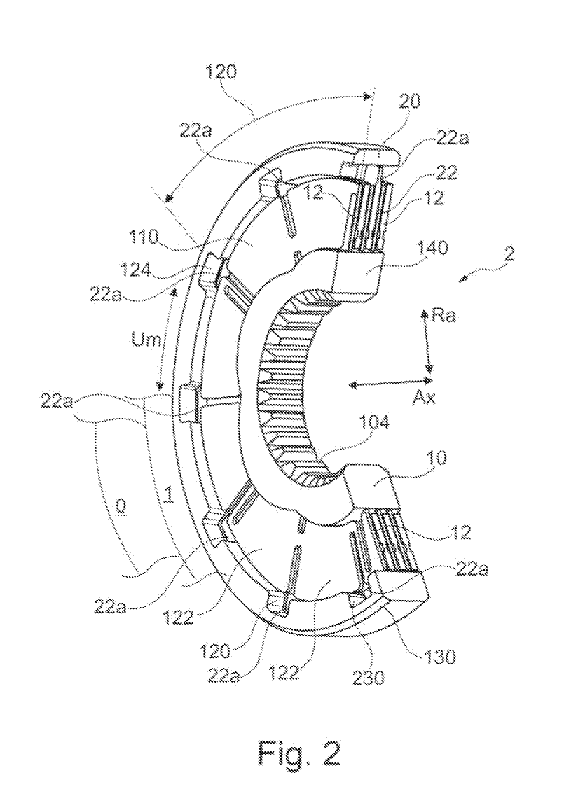

One characteristic property of multiple disc clutch 1 or friction multiple disc clutch 1 (see also FIGS. 1 and 2) in comparison to other clutches, is an arrangement of multiple friction linings axially in series, whereby equal axial force F_{Ax} (essentially corresponding to actuating force F_{Ax} of clutch 1) acts on all friction pairs. Multiple disc clutch 1 can be shifted under load, and is widely used because it is compact and cost-effective. Usually it runs in oil, and is used in automatic transmissions, in high-load main/starting clutches or in limited slip differentials. Multiple disc clutches are also used in the axles of building machines, e.g., as service and/or parking brakes; the latter often in the form of a spring-loaded brake.

In contrast to dry clutches, the advantages of multiple disc clutch 1 lie in higher power and energy input, because they are cooled with oil. The drawbacks are lower coefficients of friction compared to dry clutches, and a higher drag torque when idling due to fluid friction between the discs. Multiple disc clutch 1 consists of at least one inner disc 12 and one outer disc 22. Inner discs 12 are interlocked over inner disc carrier 10 with a shaft, e.g., a gearbox input shaft, and outer discs 12 are held by a usually internally interlocked, tubular outer disc carrier 20. In order to increase torque M that is to be transmitted, a number of inner discs 12 and outer discs 22 are arranged in an alternating manner, so that, at an equal actuating force F_{Ax}, higher torques M can be transmitted by means of an elevated friction lining surface.

In practice, the number of discs 12, 22 is limited, however, to ten to twenty discs 12, 22, because, when the clutch is engaged dynamically, discs 12, 22 are pushed together and each disc 12, 22 must shift relative to its guide. Because of this, a portion of actuating force F_{Ax} is not transferred to adjacent discs 12, 22, but, is instead supported on the affected disc carrier 10, 20. Therefore, the frictional torque that is transmitted by each individual disc 12, 22 decreases degressively from a first 12, 22 to the last disc 12, 22 in the direction in which F_{Ax} is being introduced. In other words, the torque capacity of multiple disc clutch 1 can be increased only to a certain point with the number of discs 12, 22. After that, higher actuating forces F_{Ax} are required, which involves larger diameters of discs 12, 22 and consequently a larger and reconstructed clutch 1.

The objective of the invention is to increase the torque capacity of multiple disc clutch 1 with a defined size, despite the limitation of its size, and consequently to also increase the number and the diameter of discs 12, 22. To do this, multiple disc clutch 1 with significantly higher power density is to be specified. The target is a factor of at least two. At the basis of the construction according to the invention of multiple disc clutch 1—referred to in the following as clutch 1—is the idea to establish the friction forces of clutch 1 not only between discs 12, 22, but also on periphery Um of clutch 1, in particular an outer periphery, whereupon the system according to the invention behaves in a self-enforcing manner. If a drum or a disc brake is selected as an analogy, clutch 1 according to the invention represents a combination of these two types of brakes.

According to the embodiments of the invention (see FIGS. 1 to 5) (inner) clutch discs 12, referred to in the following as inner discs 12, are configured as wedge plates 12, spring washers 12 or wedge spring washers 12. In doing so, inner disc carrier 10, configured as inner ring 10 or hub 10, referred to in the following as inner bracket 10 configured as bracket 10, exhibits contours of ramp 111. Besides grooves to hold (outer) clutch discs 22 referred to as outer discs 22, outer disc carrier 20, configured as outer ring 20, referred to in the following as outer bracket 20 configured as bracket 20, has contact surfaces (inner peripheral edge 230) for a clamping function of inner discs 12. In the event of a relative rotation of inner bracket 10 against inner disc 12, as a result of ramps 111 of inner bracket 10, segments 122 or wedges 122 of inner discs 12 can be radially displaced and positioned to the contact surfaces of outer bracket 20 by adhesive friction (radial force F_{Ra}).

FIG. 1 shows a simple embodiment of clutch assembly 1 in an exploded view, with outer bracket 20 and outer disc 22, axially movably mountable therein, which can be mounted in a non-rotatable manner opposite outer bracket 20, e.g., via radial protrusions and complementary grooves. In addition, clutch 1 exhibits inner bracket 10 and, on it, axially movably mountable inner disc 12, which fits on inner bracket 10 in an essentially non-rotatable manner. In this case, the torsional strength is primarily realized with an inner contour of inner disc 12, complementary to the outer contour of inner bracket 10. Owing to the geometry of inner disc 12 and inner bracket 10, a certain, intended rotatability of inner disc 12 in relation to inner bracket 10 is thus given. In other words, inner disc 12 can be moved in and of itself, resulting in a deformation of inner disc 12 (see below).

FIG. 2 shows a second embodiment of clutch assembly 2 with three inner discs 12 and three outer discs 22 that are arranged therein alternating in axial direction Ax of clutch assembly 2, whereby FIG. 2 shows functional clutch assembly 2. The following models are kinematically reversible, i.e., a frictional connection according to the invention between inner disc 12 or inner discs 12 and outer bracket 20, also between outer disc 22 or outer discs 22 and inner bracket 10, can be temporarily established to transmit torque M of clutch assembly 2. To do this, outer disc 22 can be configured analogously to inner disc 12 according to the invention, whereby outer bracket 20 and inner bracket 10 switch functions with regard to the frictional connection that, in such cases, can temporarily be established between outer disc 22 and the inner bracket 10.

According to the invention, inner bracket 10 and inner disc(s) 12, in particular, are configured in a specific way. This can also have an effect on the design of outer bracket 20 and outer disc(s) 22, because a friction partner, inner peripheral edge 230 of outer bracket 20, extending in peripheral direction Um and axial direction Ax, must be provided here. Inner peripheral edge 230 can be configured as a friction surface or a friction lining, whereby, in a first approximation (i.e., without grooves) it is configured similar or complementary to outer peripheral edge 130 of inner disc 12, preferentially as the inner surface of a cylinder. Outer peripheral edge 130 of outer disc(s) 22 can likewise be configured as a friction surface or a friction lining.

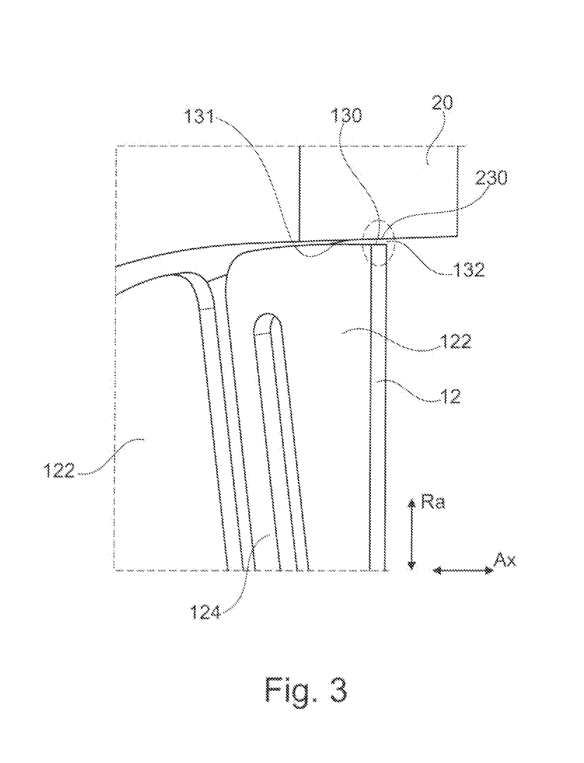

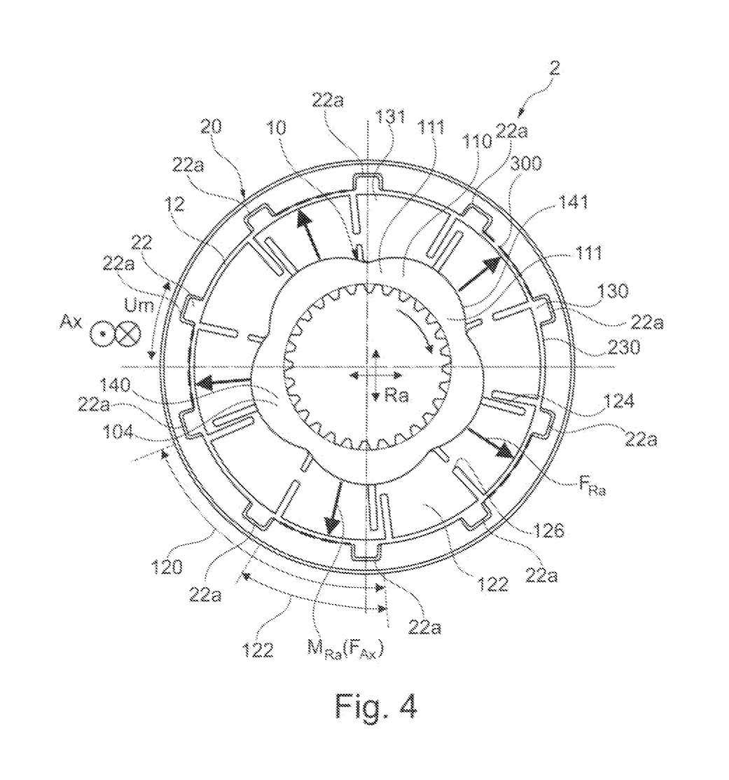

If clutch assembly 2 is not under load, i.e., clutch 1 is disengaged, there is gap 132 between outer peripheral edge 230 of inner disc 12 and inner peripheral edge 230 of outer bracket 20 (see FIG. 3). For a loaded condition of clutch assembly 2, i.e., for an engaged condition of clutch 1, gap 132 can be bridged by inner disc 12. This can occur at a number or a variety of locations or contact sections 300 (see FIG. 4) in peripheral direction Um. This (peripheral) contact section 300 that can be established between outer peripheral edge 130 of inner disc 12, or section 120 or segment 122 (see below) of inner disc 12, and inner peripheral edge 230 of outer bracket 20, is drawn into FIG. 4 as a dotted line running in peripheral direction Um (5 times).

With that, torque M_{Ra}, resulting from the generated radial forces F_{Ra} between inner discs 12 and outer bracket 20, is transmissible via clutch 1. Radial force F_{Ra} arises as a result of a relative rotation between inner bracket 10 and relevant inner disc 12 (see below). Clutch 1 also transmits torque M_{Ax} (indicated in FIG. 4 by the two dotted concentric circles) resulting from axial force F_{Ax} between inner disc 12 and outer disc 22. In other words, clutch assembly 2 according to the invention, or the clutch 1 according to the invention, transmits torque M not only through axial force F_{Ax} (torque M_{Ax}) resulting from actuating force (=F_{Ax}), but, additionally also through radial force F_{Ra} that can be established in clutch assembly 2 (torque M_{Ra}), resulting from the interaction of inner disc(s) 12 with outer bracket 20. This is explained in more detail in the following.

According to the invention, a relative rotation between inner bracket 10 and relevant inner disc 12 that results from building axial force F_{Ax} is responsible for radial force F_{Ra}. To do this, the outer contour of inner bracket 10 is configured in such a way that it causes the inherently deformable inner disc 12 to change its form in dependence of a relative rotation. This can occur in the same manner for both positive as well as negative torsion angles. It is, of course, also possible to configure this in some other way. Thus it is possible to allow deformation of inner disc 12 only for positive or only for negative angles, in other words for only one rotational direction. The deformation of inner disc 12 occurs in that inner disc 12 changes its radial dimensions. In particular, its outer diameter increases in several locations or sections (outer engaging section 131), while its inner diameter decreases in several locations or sections (inner engaging section 141).

In the depicted design examples, in a first approximation, inner disc 12 comprises circular ring section-shaped peripheral sections 120, whereby five peripheral sections 120 are provided in the present case. There can, of course, be more or less than five such peripheral sections 120 making up inner disc 12. Respective peripheral section 120 extends primarily in radial direction Ra and in peripheral direction Um, and has only a limited expansion (thickness of inner disc 12) in axial direction Ax; i.e., it is designed to have a radial surface and forms area 120 of inner disc 12. Between two peripheral sections 120, directly adjacent in peripheral direction Um, inner disc 12 consists of spring element 124, with which two relevant peripheral sections 120 are spring-suspended or spring-mounted to one another.

Spring element 124 is preferably integrally configured with inner disc 12 and extends primarily in radial direction Ra, whereby spring element 124 is configured to be elastic primarily in peripheral direction Um. With the resulting possible peripheral expansion, a relevant peripheral section 120 is at least partially radially displaceable toward the outside. This should become clearer in the following. Spring element 124 is preferably configured as bar spring 124, that is fixed on an end, in peripheral direction, of peripheral section 120 radially toward the outside and on a facing end, in peripheral direction, radially (further) inside, on a directly adjacent peripheral section 120. In approximation, spring element 124 has the form of an elongated “S”.

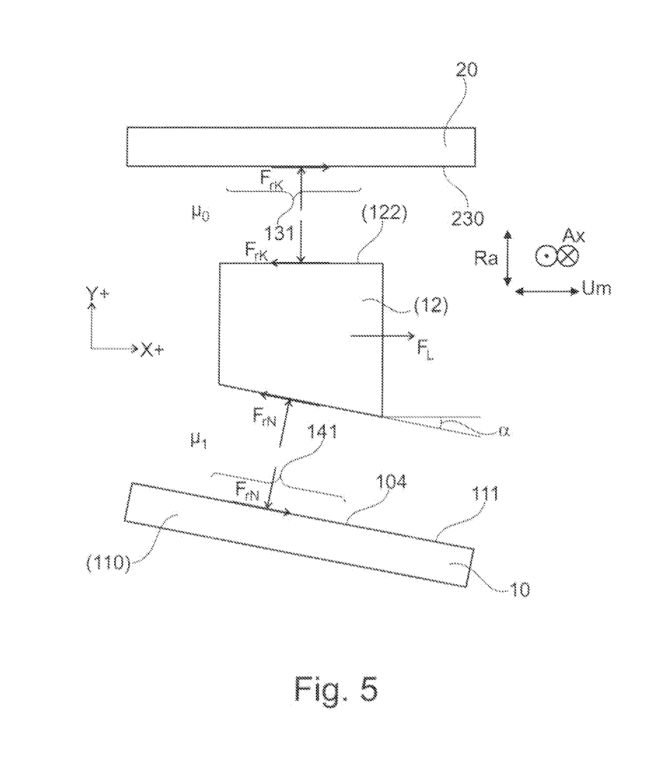

In the present case, a respective peripheral section 120 or area 120 is divided into two segments 122 or wedges 122 (see FIG. 5). Respective segment 122 or respective wedge 122 extends primarily in radial direction Ra and in peripheral direction Um, and has only a limited expansion (thickness of inner disc 12) in axial direction Ax; i.e., it is designed to have a radial surface and likewise forms area 122 of inner disc 12. Two segments 122 or wedges 122 of individual peripheral section 120 are preferably fixed to one another via fixed connection 126, configured, e.g., as crosspiece 126 or peripheral crosspiece 126, preferentially in an essentially rigid manner. Hereby, fixed connection 126 is preferentially configured to be integral with inner disc 12 and extends primarily (tangentially) in peripheral direction Um.

On outer peripheral edge 130 of inner disc 12, respective segment 122 or respective wedge 122 has an outer engaging section 131, which in the engaged condition of clutch 1, can be pressed on inner peripheral edge 230 of outer bracket 20. In the present embodiment, for a direction of rotation of clutch 1 (i.e., to the right or the left) that is always every second engaging section 131 (see FIG. 4). To do this, outer peripheral edge 130 of clutch disc 12 can be configured in a similar manner (slightly different relevant radii) or in a complementary manner (essentially identical relevant radii) to inner peripheral edge 230 of outer bracket 20.

On inner peripheral edge 140 of inner disc 12, respective segment 122 or respective wedge 122 has inner engaging section 141, which essentially always rests against outer peripheral edge 104 of inner bracket 10. In other words, inner peripheral edge 140 of inner disc 12 is configured to essentially be complementary to inner peripheral edge 104 of inner bracket 10, whereby this complementarity is the case preferably at least in unloaded, i.e., disengaged condition of clutch 1, and preferably also, as in the present design example, in loaded, i.e., engaged, condition of clutch 1. Respective segment 122 or respective wedge 122 can be pressed on outer peripheral edge 104 of inner bracket 10 in the engaged condition of clutch 1, whereby as described above, again in peripheral direction Um, every second segment 122 or every second wedge 122 is involved.

For the stated exterior form of inner bracket 10 (see FIGS. 1 and 4, see below) a peripheral area of inner bracket 10 engages on the inside of two directly adjacent segments 122 or wedges 122 of two directly adjacent peripheral sections 120. For this purpose, inner bracket 10 and two involved segments 122 or wedges 122 together exhibit complementary surfaces, i.e., essentially identical radii. The relevant section of inner bracket 10 is convex and that of the two segments 122 or wedges 122 together is concave; this can, of course, also be statically or kinematically reversed. The same procedure is applied to the two directly adjacent segments 122 or wedges 122, directly following in peripheral direction Um, of peripheral section 120, following directly in peripheral direction Um.

According to the invention, the convex sections of a periphery of inner bracket 10, or the concave sections of the inner periphery of inner disc 12 (see FIGS. 1 and 4), are respectively arranged in regular intervals on the relevant periphery, whereby a cross-section of inner bracket 12 is complementary to the inner cross-section of inner disc 12. The convex sections of inner bracket 10 are preferably configured as a preferably symmetrical elevation in relation to a circle surface (2-D view), and, in the present case, as cam 110 or cog 110, whereby cams 110 or cogs 110 are arranged in regular intervals on the periphery of inner bracket 10. The flanks of cams 110 or cogs 110 can be configured to be straight or preferentially curved.

These flanks are configured, in particular, as ramps 111 that, with the relative rotation of inner bracket 10 against inner disc 12, actuate inner engaging sections 141 of inner disc 12. In the present case, with a relative rotation in a direction, every second possible engaging section 141 is again actuated, which thus also applies to every second outer engaging section 131 arranged on the periphery that is then pressed onto inner peripheral edge 230 of inner bracket 10 (see FIG. 4). In a kinematic or static reversal, analogous depressions can also be used instead of ramps 111, in which case inner disc 12 then comprises complementary inner elevations.

In peripheral direction Um, cam 110 or cog 110 preferentially comprises two ramps 111, in each case one ascending ramp and, in the same direction continuing in peripheral direction Um, one descending ramp 111. In particular, these ramps 111 add up to a circular section (see FIG. 4), on the arc of which the associated inner engaging sections 141 of two, in peripheral direction Um directly adjacent, segments 122 or wedges 122 of two directly adjacent peripheral sections 120 can slide. In a midpoint between two ramps 111 of cam 110 or cog 110 (zenith), radially further outward, there is spring element 124 of two directly adjacent peripheral sections 120 of inner disc 12.

The connection between inner disc 12 and inner bracket 10 can also be identified or configured as a gearing, e.g., a special gearing. A mutual rotatability is limited to a radial freedom of motion of segments 122 or wedges 122 between inner bracket 10 and outer bracket 20. That is, the gearing would allow only a to and fro swinging motion of inner disc 12 relative to inner bracket 10. Everything that, with a suitable geometry of inner disc 12, allows it to, if necessary, only partially expand its radius and thus establish radial forces F_{Ra}, can be used as the gearing geometry. In the present case, the gearing between inner disc 12 and inner bracket 10 can be identified as a circular-arc gearing.

In the event of mutual rotation of inner disc 12 relative to inner bracket 10, relevant segment 122 or relevant wedge 122 is preferentially rotated essentially relative to its center. To do this, respective peripheral section 120 is rotated eccentrically, i.e., tilted, whereby a peripherally oriented section of respective peripheral section 120 moves radially outward with its radially exterior side, and a, in peripheral direction Um, opposite peripherally oriented section moves radially inward with its radially interior side. That is, with the relative rotation of inner bracket 10 against inner disc 12, peripheral sections 120 of inner disc 12 are raised, whereby half of outer engaging sections 131 of inner discs 12 jump outward and the other half moves radially inward.

FIG. 5 shows idealized friction conditions on idealized segment 122 or wedge 122 with wedge angle α for the purpose of studying a self-locking effect of inner disc 12. The coefficient of friction between segment 122 or wedge 122 and outer bracket 20 is identified as μ₀ and the coefficient of friction between segment 122 or wedge 122 and inner bracket 10 is identified as μ₁. F_{L} refers to a resulting force on segment 122 that is caused by two cutting forces F_{rK} (top) and F_{rN} (bottom). The following balance of forces occurs at segment 122:

F_{L}>F_{rK}+F_{rN}·cos α.

Using cutting forces F_{rK} and F_{rN} and the respective easily calculable radial fractions of the cutting forces F_{rK} and F_{rN} results in:

tan α>μ₀+μ₁ and therefore: α>tan⁻¹(μ₀+μ₁).

If this inequality is fulfilled, there is no self-locking effect. It is potentially possible to ignore this stipulation, because, due to a geometry and/or an adhesion of segment 122 or wedge 122 on inner bracket 10, when disengaging spring elements 124, and possibly inner bracket 10, generate a restoring force for segment 122 or wedge 122. With the above stipulation, one is on the “safe side”. It is also possible to have one or a number of return springs within inner disc 12 and/or, if necessary, even between outer bracket 20 and inner disc 12.

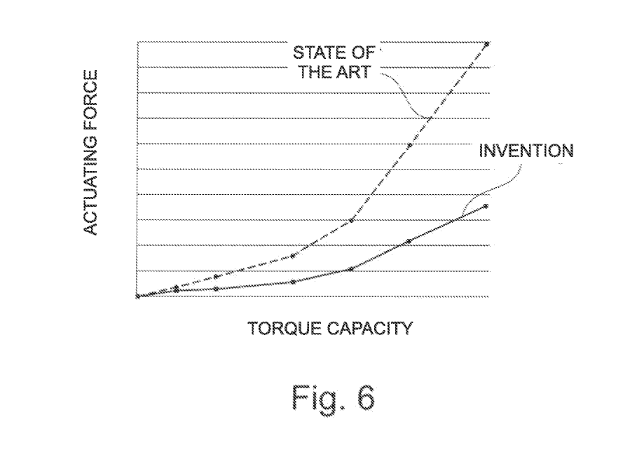

FIG. 6 demonstrates the effect of the invention. The upper line represents a state of the art in such a way that, aside from inner disc 10 according to the invention, it is identical to the invention. In other words, the state of the art has a rigid, not deformable according to the invention inner disc that cannot be radially positioned on the inside on peripheral edge 230 of outer disc carrier 20. It is easy to see that, even at smaller actuating forces F_{Ax}, the invention has a more than 100% greater torque capacity. In the example shown, for maximum actuating forces F_{Ax}, the transmissible torque capacity of the clutch assembly according to the invention grows to ca. 280% of a torque capacity of the clutch assembly in the state of the art.

The invention teaches a novel, wet-running multiple disc clutch with high power density. Using new geometry, the power density can be increased by more than a factor of two. When actuating the multiple disc clutch, wedge plates are geometrically rotated between their pitch circle diameter and their inner or outer contour of ramps of a bracket of the multiple disc clutch. In doing so, the wedge plate expands or shrinks radially and, in addition to the friction force between two axially directly adjacent discs, compression is created between a second bracket of the multiple disc clutch and the deformed wedge plate as the result of an actuating force. Without actuation by the multiple disc clutch, the wedge plate develops no gripping forces whatsoever, because the wedges have not moved radially inward nor outward.

The multiple disc clutch opens up the possibility of lowering the actuating forces for the same torque capacity or significantly increasing the transmissible maximum torque for the same actuating force. In addition, there is the option of decreasing the number of discs and thus reducing losses through drag torques in comparison to a conventional multiple disc clutch. In other words, according to the invention, a compact, safely operable multiple disc clutch with a small axial and radial space requirement at efficient power transmission is specified. Structurally the design of the multiple disc clutch is simple, and its assembly, operation and service is cost-effective.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE SIGNS

0 torque transfer system; (automatic/multiple-plate clutch/dual clutch) transmission, converter, (limited slip) differential for a vehicle, in particular for a drive train for an automobile (passenger car, passenger van, motor cycle, utility vehicle, (heaviest) goods vehicle, construction vehicle, construction machine, special vehicle etc. with gasoline or Diesel engines); further, e.g., dual mass converter, (hydrodynamic) torque converter, damper, if necessary with (torsion/torsional vibration) damping device and/or dynamic vibration absorber or (trapezoidal) centrifugal force pendulum device, axle, central, center, longitudinal differential etc., assembly or combination thereof
1 (multiple/dual/partial) clutch, (multiple/dual/partial) clutch system, in particular in the drive train and preferentially wet-running; e.g., (friction) multiple disc clutch, wedge clutch, e.g., main, starting, converter clutch, and service, parking, spring-loaded brake
2 clutch assembly of clutch 1
10 bracket, (clutch) rotation component, connected to rotation component 12 in an axially displaceable and essentially non-rotatable manner, e.g., inner ring, hub, inner disc bracket/carrier [if necessary e.g., also outer ring, outer disc bracket/carrier]
12 clutch disc, wedge plate, spring washer, wedge spring washer, rotation component, connected to bracket 10 in an axially displaceable and essentially non-rotatable manner, e.g., inner disc (clutch disc) [if necessary, e.g., also outer disc (clutch disc)]
20 (second) bracket, (clutch) rotation component, connected to rotation component 22 in an axially displaceable and essentially non-rotatable manner, e.g., outer ring, outer bracket/disc carrier [if necessary, e.g., also inner ring inner bracket/disc carrier]
22 (second) clutch disc, rotation component, connected to (second) bracket 20 in an axially displaceable and essentially non-rotatable manner, e.g., outer disc (clutch disc) [if necessary, e.g., also inner disc (clutch disc)]
104 (outer) peripheral edge of bracket 10, complementary to peripheral edge 140, depicted in unloaded and/or loaded condition
110 cam, cog of bracket 10, with preferentially two ramps 111, preferably fitted on the inside of two segments 122/areas 120, directly adjacent in peripheral direction Um, that are preferentially correspond to two different segments 120/areas 120 [if necessary, configured as a depression]
111 ramp of cam 110, a cog 110 [if necessary a depression]
120 (peripheral) section, circular ring section of clutch disc 12, primarily extending in radial Ra and peripheral direction Um, radial, area of clutch disc 12
122 segment (wedge), (radial) wedge of section 120/area 120, primarily extending in radial Ra and peripheral direction Um, radial, area of clutch disc 12
124 spring element between two sections 120/area 120 or between two segments 122/area 120 of different sections 120/areas 120, bar spring, elastic primarily in peripheral direction Urn, preferentially primarily extending in radial direction Ra
126 fixed connection of two segments 122/areas 120 of section 120/area 120, (peripheral) crosspiece
130 (outer) peripheral edge of clutch disc 12, configured to be similar or complementary to peripheral edge 230, designed with gap 132 to peripheral edge 230 (disengaged condition), if necessary configured as a friction lining
131 (outer) engaging section for bracket 20 or peripheral edge 230
132 gap between clutch disc 12 and (second) bracket 20
140 (inner) peripheral edge of clutch disc 12, configured to be complementary to peripheral edge 104 in disengaged and/or engaged condition
141 (inner) engaging section for ramp 111, cam 110, cog 110
230 (inner) peripheral edge of (second) bracket 20, configured to be similar or complementary to peripheral edge 130, d, if necessary, configured as a friction lining, preferably in a first approximation to an inner surface of a cylinder
300 (peripheral) contact section between clutch disc 12 (peripheral edge 130), section 120/area 120 or segment 122/area 120 and (second) bracket 20 (peripheral edge 230), that can be established and again detached
Ax axial direction, longitudinal direction, rotation axis of the crankshaft, the drive train, torque transfer system 0, clutch 1, clutch assembly 2, clutch disc 12, axial
Ra radial direction of the crankshaft, the drive train, torque transfer system 0, clutch 1, clutch assembly 2, clutch disc 12, radial
Um peripheral direction, circumference of the crankshaft, the drive train, torque transfer system 0, clutch 1, clutch assembly 2, clutch disc 12, (relative) twisting movements or rotations occur in peripheral direction Um, tangential
F_{Ax} axial force between clutch disc 12 and (second) clutch disc 22 to transmit torque M via clutch assembly 2 or in clutch 1, essentially corresponds to the actuating force (aside from degression)
F_{Ra} radial force (caused by the relative rotation between bracket 10 and clutch disc 12 due to building axial force F_{Ax}) between clutch disc 12 and (second) bracket 20 for transmission of torque M_{Ra} via clutch assembly 2 or in clutch 1
M torque (M=M_{Ax}+M_{Ra})
M_{Ax} torque to be transmitted through clutch assembly 2 or via clutch 1 as a result of axial force F_{Ax}
M_{Ra} torque to be transmitted through clutch assembly 2 or via clutch 1 as a result of radial force F_{Ra}
α angle of idealized segment 122 in FIG. 5
μ₀ coefficient of friction between segment 122/area 120 and (second) bracket 20
μ₁ coefficient of friction between segment 122/area 120 and bracket 10
F_{L} in FIG. 5 resulting force on idealized segment 122
F_{Rk} in FIG. 5 upper cutting force on idealized segment 122 as a result of μ₀
F_{rN} in FIG. 5 lower cutting force on idealized segment 122 as a result of μ₁

What is claimed is:

1. A clutch disc for a first bracket of a clutch assembly, a clutch, a transmission or a differential of the drive train of a vehicle, comprising:
at least two sections, wherein:
the at least two sections of the clutch disc are arranged in the clutch disc in a radial direction of the clutch disc and are movable relative to one another.

2. The clutch disc recited in claim 1, wherein the at least two sections are configured to be movable relative to one another in such a way that an outer peripheral edge of the clutch disc can be fitted on an inner peripheral edge of a second bracket and held by adhesive friction.

3. The clutch disc recited in claim 1, wherein the clutch disc includes an inner peripheral edge and the clutch disc is configured such that it can be mounted on the first bracket in an essentially form-fitted and mostly non-rotatable manner.

4. The clutch disc recited in claim 3, wherein the at least two sections of the clutch disc are movable relative to one another in the radial direction through an outer peripheral edge of the first bracket that is complementary to the inner peripheral edge of the clutch disc.

5. The clutch disc recited in claim 1, wherein the clutch disc is configured as a spring washer, whereby the at least two sections of the clutch disc are spring-mounted to one another with a spring element, primarily elastic in a peripheral direction.

6. The clutch disc recited in claim 1, wherein the clutch disc is configured as a wedge plate, whereby one section of the at least two sections is configured to approximate a wedge, which can be clamped between the first bracket and a second bracket.

7. The clutch disc recited in claim 1, wherein the clutch disc is configured as a wedge plate, whereby one segment of the at least two sections is configured to approximate a wedge, which can be clamped between the first bracket and a second bracket.

8. The clutch disc recited in claim 7, further including an engaging section for a cam, a cog, or a ramp of the first bracket, through which the one segment or the clutch disc is radially displaceable.

9. The clutch disc recited in claim 7, further including an engaging section for a peripheral edge of a second bracket, through which the first bracket, the one segment or the clutch disc can be pressed to the second bracket.

10. A clutch assembly for a clutch, a transmission or a differential of a drive train of a vehicle including a clutch disc to transmit a first torque resulting from an axial force, wherein:
the clutch disc is configured to be inherently movable in a radial direction of the clutch assembly in such a way, that a radial force can be established in the clutch assembly via the clutch disc, through which the torque is further transmissible.

11. The clutch assembly recited in claim 10, further including:
a first clutch rotating component having at least one clutch disc; and,
a second clutch rotating component having at least one clutch disc, wherein:
the respective clutch rotating component is movably mounted in an axial direction with the relevant clutch disc and is held in an essentially form-fitted manner in a peripheral direction of the clutch assembly.

12. The clutch assembly recited in claim 11, wherein a second torque is transmissible via a closed linkage that can be set up axially between the respective clutch discs; and,
a third torque is transmissible via a closed linkage that can be set up radially between the clutch disc and the second clutch rotating component.

13. The clutch assembly recited in claim 11, further comprising:
two adjacent areas of the clutch disc arranged to be movable relative to one another in the clutch disc with a spring element, and a radial movability of the two adjacent areas of the clutch disc are realized via the spring element, wherein:
for an engaged condition of the clutch assembly:
the first clutch rotating component fits at least one of the two adjacent areas of the clutch disc, at least in sections, on the second clutch rotating component by adhesive friction in a peripheral direction.

14. The clutch assembly recited in claim 11, further comprising:
two adjacent areas of the clutch disc arranged to be movable relative to one another in the clutch disc with a spring element and an essentially fixed connection, and a radial movability of the two adjacent areas of the clutch disc are realized via the spring element, wherein:
for an engaged condition of the clutch assembly:
the first clutch rotating component fits at least one of the two adjacent areas of the clutch disc, at least in sections, on the second clutch rotating component by adhesive friction in a peripheral direction.

15. The clutch assembly recited in claim 11, further comprising:
at least one ramp or one depression on the first clutch rotating component;
a complementary or corresponding engaging section on an area of the clutch disc; and,
another engaging section of the area of the clutch disc, wherein:
with a relative rotation between the first clutch rotating component and the clutch disc, the complementary or corresponding engaging section is radially displaceable via the at least one ramp or the depression and the another engaging section can be fitted radially on the second clutch rotating component.

16. The clutch assembly recited in claim 15, wherein the complementary or corresponding engaging section is primarily opposite the another engaging section.

17. The clutch assembly recited in claim 11, further comprising:
areas of the clutch disc; and,
a gearing configured between the first clutch rotating component and the clutch disc, wherein:
with a relative rotation of the first clutch rotating component relative to the clutch disc, the gearing radially displaces the areas of the clutch disc.

18. The clutch assembly recited in claim 11, further comprising:
a first radius of a peripheral edge of the second clutch rotating component forming a first contour; and,
a second radius of an engaging section of the clutch disc forming a second contour, where the second contour is aligned and fitted to the first contour and the first and second radii are essentially identical.

19. The clutch assembly recited in claim 11, wherein the first clutch rotating component exhibits a cross section in the shape of a polygon or a regular star.

20. The clutch assembly recited in claim 11, wherein the first clutch rotating component exhibits a plurality of cams and/or cogs, that run regularly in a peripheral direction.

21. The clutch assembly recited in claim 11, wherein the first clutch rotating component is configured as a first bracket.

22. The clutch assembly recited in claim 11, wherein the first clutch rotating component is configured as an inner ring, and the clutch disc is configured as an inner disc.

23. The clutch assembly recited in claim 20, wherein the second clutch rotating component is configured as a second bracket.

24. The clutch assembly recited in claim 11, wherein the second clutch rotating component is configured an outer ring, and the second clutch disc is configured as an outer disc.

25. A clutch assembly including the clutch disc recited in claim 1.

26. A clutch or torque transfer system, in particular a dual clutch, automatic transmission or differential for a drive train of a vehicle, comprising the clutch disc recited in claim 1.

27. A clutch or torque transfer system, in particular a dual clutch, automatic transmission or differential for a drive train of a vehicle, comprising the clutch assembly recited in claim 10.
